(19) United States
(12) Patent Application Publication
(10) Pub. No.: US 2021/0214889 A1
(43) Pub. Date: Jul. 15, 2021

(54) UTILITY PARACORD

(71) Applicant: John Ryan Melendez, Austin, TX (US)

(72) Inventor: John Ryan Melendez, Austin, TX (US)

(21) Appl. No.: 16/743,370

(22) Filed: Jan. 15, 2020

(51) Int. Cl. D07B 1/02; D04C 1/12

(52) U.S. Cl. CPC D07B 1/025; D07B 2201/2041; D07B 2201/1096; D04C 1/12

(57) ABSTRACT

Embodiments disclose a utility model which is related to an advance utility paracord where a first plurality of strands and a second plurality of strands are braided. The first plurality of strands is braided and are made of one or more non-metallic materials. The second plurality of strands has a braided PE fishing line, a tinder line, and a thread. A non-transparent sheath encapsulates the first plurality of strands and the second plurality of strands.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

Embodiments disclosed herein generally relate to an apparatus for utility paracord. More so, the present invention relates to a multipurpose utility paracord.

### Description of the Related Art

With the continuous improvement of living standards, people are increasingly high requirements for the quality of life. Survivalists and outdoor adventurers make conscious efforts to equip themselves with what they will need to survive in the wild. Some problems they will encounter are easy to expect, others will be surprises and therefore unwelcomed challenges, especially if they're not equipped to deal with the issues. Paracord was made possible through the invention of nylon in 1935 by Wallace Hume Carothers for DuPont. The core of 550 paracord is usually made up of 7 strands, which are, in turn, made up of three smaller strands each. Paracord is a must have for any survival kit or bug out bag. Also known as parachute cord or 550 cord, it can be used for countless survival techniques.

There are several types of paracord available in the market. Many of these paracords are useful for outdoor adventure enthusiasts. Adventure enthusiasts use these paracords as basic camping and outdoor adventure toolkit. Many of these paracords can be used as a fishing line. Typically, paracords use monofilament for application in fishing lines. Such paracords suffer from several disadvantages, when used for fishing applications, such as low strength to size ratio, causing slower fall speed and lesser casting distance. In addition, many of these utility paracord have high stretch leading to less feel of bites of fish, and so forth. Many utility paracord sink in the water, limiting their usefulness. Paracords that use metal wire have memory of their own and are difficult to handle. Most of the monofilament or fluorocarbon based paracords deteriorate rather quickly, especially when exposed to salt-water environment.

Therefore a need exists for a novel assembly which improves the arrangements in similar field. The invention focuses on providing a utility paracord that has multiple uses and exceed MIL-STD-C-5040H. The utility paracord is durable and has long life. It further allows a utility paracord that is not be operated in salt-water environment without compromising its life.

### BRIEF SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is a general object of the present invention to provide an improved form of assembly which relates to a utility paracord that has multiple uses and exceed MIL-STD-C-5040H.

It is also the objective of the invention to provide a utility paracord that has long life.

It is moreover the objective of the invention to provide an assembly which has a utility paracord and that is not be operated in salt-water environment without compromising its life.

It is further the objective of the invention to provide a smart assembly which is a utility paracord that can be used to start fire even after getting wet.

It is still the objective of the invention to provide a utility paracord that is useful for leatherwork.

It is further the objective of the invention to provide a utility paracord which provides ease in portability and operational use of product.

More specifically, it is the principal object of this invention to provide an architecture which is made of high-quality material and maintains its effectiveness after repeated usage.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### DESCRIPTION OF THE DRAWINGS

Having thus described the disclosure in general terms, reference will now be made to the accompanying FIGURE, wherein:

FIG. 1 illustrates an undergarment with a utility paracord, in accordance with an embodiment of the present disclosure.

It should be noted that the accompanying FIGURE are intended to present illustrations of exemplary embodiments of the present disclosure. This FIGURE is not intended to limit the scope of the present disclosure. It should also be noted that accompanying FIGURE is not necessarily drawn to scale.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Reference will be made in detail to selected embodiments of the present disclosure in conjunction with accompanying FIGURES. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying FIGURE is intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and “like”, herein do not denote any order, ranking, quantity, or importance, but rather are used to distinguish one element from another. Further, the terms “a” and “an” herein do not denote a limitation of quantity, but rather denote the presence of at least one of the referenced item.

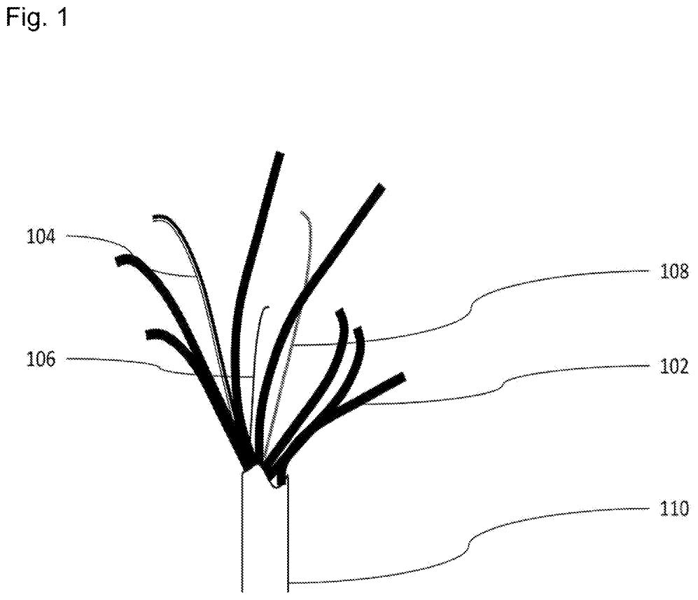

FIG. 1 illustrates an undergarment with a utility paracord 100, in accordance with an embodiment of the present disclosure. The utility paracord 100 has a first plurality of strands 102, a second plurality of strands and a non-transparent sheath 110.

The first plurality of strands 102 are braided and made of one or more non-metallic materials. For example, braided strands can be made of polyester. This makes the utility paracord 100 lightweight and more flexible compared to metal based paracords. In an embodiment of the present disclosure, the first plurality of strands 102 has 07 strands and exceeds MIL-STD-C-5040H.

The second plurality of strands has a braided PE fishing line 104, a tinder line 106, and a waxed thread 108. The braided PE fishing line 104 can be used for fishing. The braided PE fishing line 104, for example, can be rated 40 lbs. In an embodiment of the present disclosure, the braided PE fishing line 104 has a stretch of approximately 4%. The braided PE fishing line 104 floats on the water. The tinder line 106 is made of waxed cotton. The tinder line 106 can be used for fire making. The waxed thread 108 can be used for leathercraft and sewing canvas. For example, a waxed thread can be used for hand sewing wallets, belts, bags, leather accessories, moccasins, shoes, saddlery, and so forth. The waxed thread easily pass through the stitching holes and keeps it from being beaten up too quickly. A waxed thread is stiffer, water resistant, and more durable.

The non-transparent sheath 110 encapsulates the first plurality of strands 102 and the second plurality of strands. In an embodiment of the present disclosure, the non-transparent sheath 110 is made of nylon.

In an embodiment, the utility paracord 100 is used to make a bracelet. It will be understood to a person ordinarily skilled in the art that the utility paracord 100 can be used for other purposes without affecting the scope of the invention.

The utility paracord 100 has no memory and helps to reduce line twist. Moreover, the utility paracord 100 is resistant to salt-water environment and has longer life. In addition, the utility paracord 100 can be used for making fire, fishing and leather craft and sewing canvas.

Accordingly, while only a few embodiments of the present invention have been shown and described, it is obvious that many changes and modifications may be made again without departing from the spirit and scope of the invention.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A utility paracord comprising of:
a first plurality of strands, wherein the first plurality of strands are braided, wherein the first plurality of strands are made of one or more non-metallic materials;
a second plurality of strands comprising a braided PE fishing line, a tinder line, and a waxed thread; and
a non-transparent sheath encapsulating the first plurality of strands and the second plurality of strands.

2. The utility paracord of claim 1, wherein the braided PE fishing line 104 has a stretch of approximately 4%.

3. The utility paracord of claim 1, wherein the one or more non-metallic materials is polyester.

4. The utility paracord of claim 1, wherein the thread is waxed.

5. The utility paracord of claim 1, wherein the tinder line is made of waxed cotton.

6. The utility paracord of claim 1, wherein the non-transparent sheath is made of nylon.

7. The utility paracord of claim 1, wherein the braided PE fishing line is rated 40 lbs.

8. The utility paracord of claim 1, wherein the thread is 150 D 1 mm.

9. The utility paracord of claim 1, wherein the first plurality of strands has 07 strands.

10. A utility paracord comprising of:
a first plurality of strands, wherein the first plurality of strands are made of one or more non-metallic materials;
a second plurality of strands comprising a PE fishing line, a tinder line, and a thread, wherein the braided PE fishing line 104 has a stretch of approximately 4%, wherein the tinder line is made of waxed cotton; and
a non-transparent sheath encapsulating the first plurality of strands and the second plurality of strands.

11. The utility paracord of claim 10, wherein the one or more non-metallic materials is polyester.

12. The utility paracord of claim 10, wherein the thread is waxed.

13. The utility paracord of claim 10, wherein the first plurality of strands are braided.

14. The utility paracord of claim 10, wherein the non-transparent sheath is made of nylon.

15. The utility paracord of claim 10, wherein the PE fishing line is rated 40 lbs.

16. The utility paracord of claim 10, wherein the thread is 150 D 1 mm.

17. The utility paracord of claim 10, wherein the first plurality of strands is 7.

18. The utility paracord of claim 10, wherein the PE fishing line is braided.
